(19) United States
(12) Patent Application Publication
(10) Pub. No.: US 2012/0239503 A1
(43) Pub. Date: Sep. 20, 2012

(54) SHARED INTERACTIVE MOBILE ADVERTISING PLATFORM SYSTEM AND METHOD

(76) Inventor: Peter C. Cohen, Williamsville, NY (US)

(21) Appl. No.: 13/421,294

(22) Filed: Mar. 15, 2012

Related U.S. Application Data
(60) Provisional application No. 61/452,739, filed on Mar. 15, 2011.

(51) Int. Cl. G06Q 30/02

(52) U.S. Cl. 705/14.64

(57) ABSTRACT

A shared interactive mobile advertising platform with a messaging display is provided that allows for advertising to an audience. The messaging display displays advertising campaigns in the form of response codes and data collection destinations, and displays advertising messages. Advertising users generate or create the advertising campaign and rent advertising space on the display from the platform owner. A member of the audience sees the advertising campaign and if he is interested he enters the response code and the data collection destination information into a personal communication device. The shared interactive mobile advertising platform sends a response to that member in the form of a discount, sale, coupon et cetera and the response and may be redeemed by the member. The advertising user only receives input from interested members of the audience and can focus on marketing to these members in the future.

### CROSS REFERENCE TO RELATED APPLICATION

This application claims priority to U.S. Provisional Application having Ser. No. 61/452,739, filed on Mar. 15, 2011 the entire disclosure of which is hereby incorporated herein by reference.

### FIELD OF INVENTION

This invention is directed to interactive advertising systems and methods.

### BACKGROUND OF INVENTION

Increasingly, advertisers are trying to find new and better ways to reach their target audience. Print media has decreased recently, while electronic media has increased. As a result, users are constantly exposed to electronic media and messages throughout the day. Thus, advertisers are always looking for ways to electronically send out their product information to consumers. The key is for advertisers to find an inexpensive and effective way to advertise, while ensuring that the electronic media is reaching the appropriate target audience.

### SUMMARY OF THE INVENTION

Accordingly, it is the subject of this invention to provide a shared interactive mobile advertising platform (sometimes referred to herein as SIMAP) system and method that provides inexpensive electronic advertising that will reach the appropriate target audience. The method of advertising is directed to an audience having members and includes providing the shared interactive mobile advertising platform and providing a messaging display for use therewith. Advertising users generate or create the advertising campaign via the use of a response code tied to a data destination, for example with text messaging a short code and a keyword that is to be used in connection with the advertising campaign. The short code identifies a specific user, advertising campaign, vendor or sponsor and the like, so when a member of the audience decides to respond to the short code via any social media platform, for example text, email, Facebook® and Twitter®, the SIMAP system provides feedback directly to the advertising user based on the feedback from the audience. The social media platform includes text, email, Facebook®, Twitter® and other social media platforms now known or to be developed in the future. The short code and the key word are displayed on the messaging display. In addition, the advertising user creates or generates advertising messages that are displayed on the messaging display. The messaging display is mobile and may be placed in a location for a predetermined period of time. The advertising user rents advertising space on the messaging display from the platform owner. A member of the audience sees the advertising campaign (short code and keyword) and if he or she is interested he or she enters the short code and keyword on his or her personal communication device, or hand held device or cell phone. The shared interactive mobile advertising platform sends a response to that member of the audience in the form of a discount, sale, coupon et cetera and the response is viewable on the personal communication device, hand held device, cell phone or other device, for example an iPad or tablet computers, and may be redeemed by the member or the member may take other action depending on the response received. The messaging display is located such that it is viewable by the members of the audience.

In addition, the advertising user is provided with instant feedback and valuable audience or consumer data. The advertising user may advantageously use this valuable consumer data at another time, knowing in advance the member is interested in its products or services.

The system for shared interactive mobile advertising platform includes the messaging display for displaying an advertising campaign having a short code and a keyword; an advertising space defined on the messaging display and the advertising space for displaying the short code and the key word, an advertising message displayed in the advertising space defined on the messaging display, wherein the shared interactive mobile advertising platform is mounted on a vehicle or is otherwise made mobile. The SIMAP system also includes a specially programmed general purpose computers each having a processor and a memory and for storing short code data, keyword data, advertising message data and displaying the short code data, keyword data, advertising message data on the messaging screen. One of the specially programmed general purpose computers is on board the vehicle, for example a truck, and there are also off-site shared computers for managing the text marketing and/or social media responses from the members of the audience in one of the preferred embodiments. The system has an interface such that communication between the shared interactive mobile advertising platform and the hand held devices of the audience is possible.

### BRIEF DESCRIPTION OF THE DRAWING FIGURES

FIG. 1 is a diagrammatic view showing step one of a method wherein advertising users create an advertising campaign that includes a short code and a keyword for use with an shared interactive mobile advertising platform.

FIG. 2 is a diagrammatic view showing an audience that views the advertising campaign (short code and keyword) and advertising message wherein the members of the audience have an opportunity to “opt in” to the advertising campaign by replying to the advertising campaign.

FIG. 3 is a diagrammatic view showing a welcome or confirmation message sent to a member of the audience who replied to the short code and keyword message and “opted in.”

FIG. 4 is a diagrammatic view showing the entire shared interactive mobile advertising platform system and method with arrows indicating the flow of information including messages.

### DETAILED DESCRIPTION OF THE INVENTION

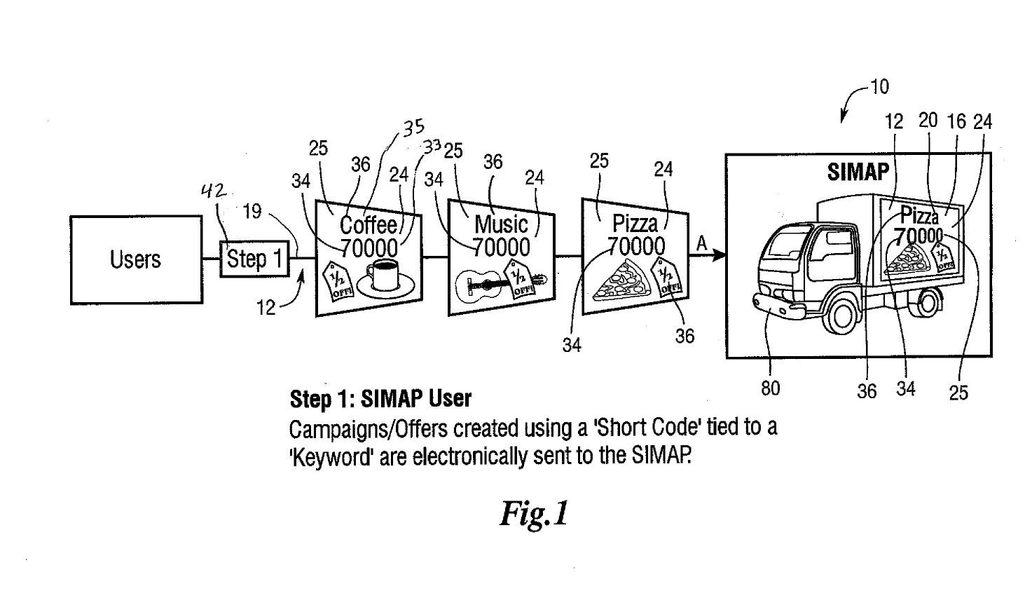

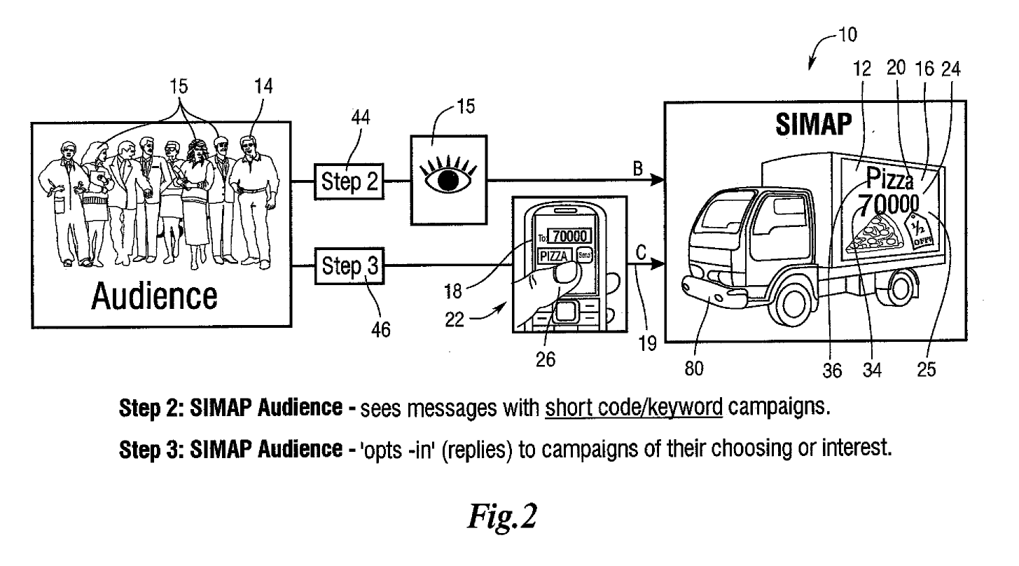

Referring now to FIGS. 1 and 2, a shared interactive mobile advertising platform system and method 10 is shown. The shared interactive mobile advertising platform system and method 10 includes a shared interactive mobile advertising platform 12 (sometimes referred to herein in this description as SIMAP 12 and in the drawing figures as SIMAP) that is permission based. Permission based means a member 14 of an audience 15 “opts in” to use or access the shared interactive mobile advertising platform 12. As shown, the SIMAP 12 is mounted on a vehicle 80.

The SIMAP 12 takes advantage of existing technologies to allow advertising users 30 to use the SIMAP 12 method in order to digitally and/or electronically reach members 14 of an audience 15. The advertising users 30 receive live measureable feedback from the audience 15. The advertising users 30 can then immediately modify their advertising messages 25 based on the feedback from the audience 15 in order to focus on the wants and desires of the members 14 of the audience 15. The technologies utilized by the SIMAP 12 include, but are not limited to, the following:

web connected electronic messaging displays 16, for example light emitting diode (LED), organic light emitting diode (OLED) and plasma displays 16;

personal communication devices 18 including, but not limited to, mobile and smart phones, cell phones, tablets and computers;

wireless communication networks, both public and private, including wireless networks (Wifi), wide area network (WAN), local area network (LAN), public internet, and mobile carriers, for example Verizon®;

social networking services, including but not limited to: Facebook® and Twitter® and instant messaging; and,

electronic communication methods including, but not limited to text, short message service, email, blog, and internet.

All of the above-described existing technologies are well known to those having ordinary skill in the art and are therefore not described herein in greater detail.

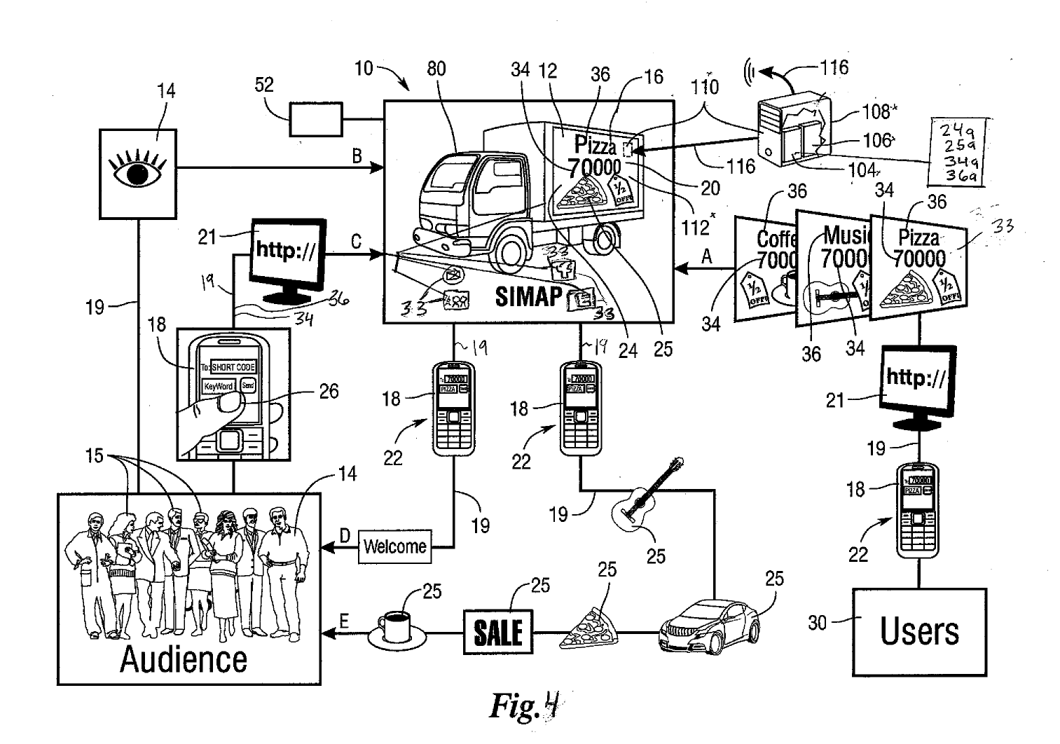

As shown in FIG. 4, the shared interactive mobile advertising platform system and method 10 includes the shared interactive mobile advertising platform 12 having a web connected electronic portable messaging display 16 with advertising space 20, personal communication devices 18 including mobile phones, cell phones, smart phones and other hand held devices; wireless communication networks 19; specially programmed general purpose computer 110 computers; and, connectivity to the internet 21 that are tied to social marketing services 22. The social marketing services 22 include, but are not limited to, text, short message service (hereinafter sometimes referred to as SMS), e-mail and instant messaging (hereafter sometimes referred to as IM). This allows an advertising user 30, for example an individual, organization, or business to directly interact with the audience 15 in order to collect, respond to and solicit feedback from the audience 15. It is pointed out that social marketing services, text, SMS, e-mail, and IM and the implementation, use and operation of each of these technologies is well known to those having ordinary skill in the art and are therefore not described herein in greater detail. In addition, personal communication devices, including mobile phones and hand held devices, wireless communication networks; the use, operation and programming a general purpose computer; enabling connectivity to the internet and social marketing services are well known to those having ordinary skill in the art and are therefore not described in greater detail herein.

As will be described in greater detail presently, the shared interactive mobile advertising platform system and method 10 promotes audience 15 awareness regarding the products, services, ideas, events, promotions, discounts, surveys, giveaways, opinions, contests, deals, coupons, clubs, meetings, events, and et cetera being offered by the advertising user 30. The list of possible items that are promotable by the advertising user 30 is virtually limitless. In addition, the shared interactive mobile advertising platform 12 is owned by a platform owner 52, and the platform owner 52 charges the advertising user 30 a fee in exchange for the right to use the advertising space 20 that is available on the messaging display 16. The advertising user 30 then has right to display an advertising campaign 24 on the messaging display 16 of the shared interactive mobile advertising platform 12. Thus, the advertising user 30 pays a fee for the rights to use the advertising space 20 on the messaging display 16 of the shared interactive mobile advertising platform 12, and the platform owner 52 receives a fee in exchange.

As shown in FIG. 1, in “Step 1” (indicated by reference numeral 42) the method of using the shared interactive mobile advertising platform 12 of the shared interactive mobile advertising platform system and method 10 begins when the advertising user 30 creates an advertising campaign 24. The advertising campaign 24 includes a response code 35 that is tied to a data collection destination 33. The response code 35 can be sent to many different data collection destinations 33, for example websites like Facebook®, Twitter®, and custom designed webpages, as shown in FIG. 4. In the example of text marketing and as shown in FIG. 1, the response code 35 is in the form of a keyword 36 such as “Coffee”, “Music” and “Pizza”, and the data collection destination 33 is in the form of a short code 34 that is the numeral 70000. The short code 34 and the keyword 36 may be sent to the shared interactive mobile advertising platform 12 in a wireless manner or via wire, or the short code 34 and keyword 36 may be programmed directly into the shared interactive mobile advertising platform 12 by the platform owner 52 or the advertising user 30. The short code 34 is a telephone number that is typically shorter than a standard seven digit telephone number. The short code 34 is used to address items such as SMS messages. The keyword 36 identifies the product or service that is indicative of the advertising campaign 24. The short code 34 and the keyword 36 are displayed on the advertising space 20 of the messaging display 16. It is pointed out that and short codes 34 and keywords 36 and the creation and use thereof are well known to those having ordinary skill in the art and they are therefore not described in greater detail herein. In addition, the user 30 creates advertising messages 25 for display on the messaging display 16. The advertising messages 25 include, but are not limited to, graphics, numerals, printed indicia, words, streaming graphics and combinations thereof, and can include product sales, services, ideas, events, promotions, discounts, surveys, giveaways, opinions, contests, deals, coupons, clubs, meetings and event information can be advertised. In another preferred embodiment the display 16 is capable of displaying streaming video, display games that the members 14 of audience 15 can play via their personal communication devices 18, and the display 16 can be manipulated by the audience 15 speaking or touching the display 16 in order to draw more attention from the audience 15. The advertising messages 25 are displayed on the advertising space 20 of the messaging display 16 along with the short code 34 and keyword 36.

The shared interactive mobile advertising platform 12 includes a specially programmed general purpose computer 110 having a memory element 104, a processor 106, and an interface element 108. The memory component 104 stores at least the advertising campaign data 24a, keyword data 34a, short code data 36a, and advertising message data 25a. The memory element 104 is a standard memory element the use and operation of memory elements is well known to those having ordinary skill in the art and is therefore not described in greater detail herein. The processor 106 is a standard processor, and the use, programming and operation of processors are well known to those having ordinary skill in the art.

The processor 106 processes all the advertising campaign data 24a, keyword data 34a, and advertising message data 25a and generates an output 112 wherein the output 112 is displayed on the messaging display 16. The outputs 112 include, for example printed indicia, short codes 34 and keywords 36, advertising messages 25 and/or graphics that are displayed on the messaging display 16.

The interface element 108 of the shared interactive mobile advertising platform 12 is for transmitting and receiving the above-described data including the short codes and key words 34, 36, and member 14 responses to the advertising campaign 24 sent by the hand held devices 18. The interface element 108 is capable sending and receiving data (as indicated by reference number 116). Interface elements and the use and operation of interface elements are well known to those having ordinary skill in the art and they are therefore not described herein in greater detail herein.

As previously mentioned, in “Step 1” (indicated by reference numeral 42) the method of using the shared interactive mobile advertising platform 12 begins by the advertising user 30 creating the short code and key word 34, 36 and advertising message 25 for a text messaging campaign. As shown the short code 34 is, for example, the number 70000 and there are three illustrative keywords 36, namely, “Coffee”; “Music”; and “Pizza” along with the advertising message 25 in the form of printed indicia (words and graphics), namely a coffee cup “½ OFF!”; a guitar “½ OFF!”; and a slice of pizza “½ OFF!”. The advertising user 30 or the platform owner 52 electronically transmits/wirelessly uploads from a hand held device (or manually programs) the advertising campaign 24 (short code 34 and keyword 36 and advertising message 25) into the shared interactive mobile advertising platform 12 (as indicated by the arrow designated A).

As shown in FIG. 2, when the member 14 of the audience 15 sees (“Step 2” as indicated by reference numeral 44) the advertising message 25 and the advertising campaign 24 (the short code 34 tied to the keyword 36) on the messaging display 16 he or she has the opportunity to analyze what he or she saw (as indicated by the arrow designated B). If the member 14 is interested in the advertising campaign 24, then he or she “opts in” (indicated by reference number 26) or in other words replies to the advertising campaign content 24 by typing the keyword 36 and short code 34 on his or her mobile device 18 (Step 3 as indicated by reference numeral 46 and as indicated by the arrow designated C). Some members of the audience 15 may not “opt in” by simply not responding to the advertising campaign 24 and advertising message 25 displayed on the messaging display 16.

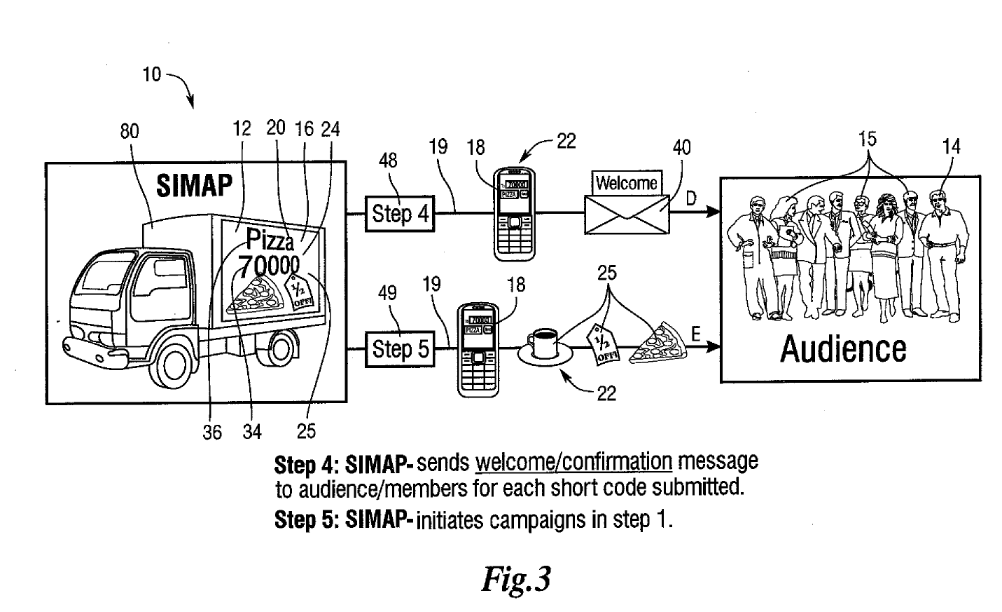

As shown in FIG. 3, upon receipt of the incoming short code 34 and key word 36 the shared interactive mobile advertising platform 12 sends a response message 40 in reply to the member 14 of the audience 15 who replied (Step 4 as indicated by reference number 48 and as indicated by the arrow designated D). The response message 40 is the advertising campaign 24 and can include the word “Welcome,” a confirmation message that the member 14 may view immediately, or both. The response message 40 can also be the word “Welcome” along with a coupon, a discount, a sale, and or other advertising message 25 (Step 5 as indicated by reference numeral 49 and as indicated by the arrow designated E). The member 14 immediately receives a response message 40 from the shared interactive mobile advertising platform 12 as soon as the member 14 sends the short code 34 and keyword 36. As previously mentioned, the short code 34 and keyword 36 are directed to text marketing. FIG. 4 is diagrammatic view showing the entire shared interactive mobile advertising platform system and method 10. The member 14 then redeems the offer from the advertising user 30 as indicated on his or her hand held device/cell phone/mobile device 18. As indicated above, the SIMAP system and method 10 is not limited to text messaging only, and in other preferred embodiments the response code 35 and data collection destination 33 allow for additional ways to identify the members 14 when they “opt in” such as by email address, Facebook® name, Twitter® name, IM screen name or other social media account usernames.

In one of the preferred embodiments, the platform owner 52 rents or purchases a messaging display 16, for example a light emitting diode (LED) panel type display. The platform owner 52 or the advertising user 30 sends, inputs manually or wirelessly uploads the advertising message 25 and the advertising campaign 24 (the short code 34 tied to the keyword 36) to the SIMAP 12. The messaging display 16 is supported on a truck 80 in one of the preferred embodiments, but in other embodiments the truck 80 may be replaced with a trailer, a car, or any suitable transport, or the messaging display 16 may be embodied to have a stand and is placed in front of a business or building and moved from business to business or location to location as desired. The advertising user 30 rents the advertising space 20 on the messaging display 16 from the platform owner 52. The SIMAP 12 can be readily moved from one location to another location after a predetermined amount of time, for example after an agreement between the advertising user 30 and platform owner 52 expires. In addition, the SIMAP 12 is fully functional and useable while in motion, for example when the vehicle 80 (embodied as a truck) on which it is mounted is in motion.

In addition, it is envisioned that the member 14 and/or the audience 15 in general may not actually directly respond to the advertising campaign 24. For example, the member 14 and/or the audience 15 upon seeing the messaging display 16 might know of a friend that would be interested in the subject matter of the advertising message 25, and member 14 forwards the friend the keyword 36 and short code 34. The friend may then electronically text message the keyword 36 and short code 34 and receive the coupon or discount code in that manner.

One of the advantages of the shared interactive mobile advertising platform system and method 10 is that the advertising user 30 receives the phone numbers of members 14 that “opt-in” to take advantage of the advertising campaign 24. The advertising user 30 can then collect this phone number information for use at a later date. For example, the advertising user 30 can then use the phone number information for text marketing. This text marketing would not be considered to be “spam” because the member 14 of the audience 15 actually contacted the advertising user 30 first, and thus the advertising user 30 knows in advance that the member 14 is interested in similar types of goods or services and has been given permission to be contacted by the advertising user.

In another preferred embodiment, the shared interactive mobile advertising platform 12 may be used for religious or political messages. In another preferred embodiment, the shared interactive mobile advertising platform 12 may be used for voting. The advertising message 25 and the advertising campaign 24 (the short code 34 tied to the keyword 36) may include information about how to vote for one item over another. For example, at a battle of the bands event, the advertising campaign 24 indicates that a member 14 of the audience 15 should send a short code 34 and keyword 36 in order to vote for band A or in order to vote for band B, et cetera. It is expected that the advertising message 25 could be almost any message that would encourage interactive communication between an advertising user 30 and a member 14 that “opts in” including the friends and family of that member 14.

In another preferred embodiment, it is envisioned that the advertising user 30 or other message sender would change or modify their advertising or other message, based on feedback from the members 14 of the audience 15. For example, if a pizza shop displays an advertising message 25 asking whether they prefer pizza with pepperoni or sausage and the audience 15 overwhelmingly enters the short code 34 and keyword 36 for pepperoni as compared to those entering the short code 34 and keyword 36 for sausage, then the pizza shop may send out a coupon or discount code directed to pepperoni pizza to the members 14 that “opted in” and voted for pepperoni.

It will be appreciated by those skilled in the art that while the shared interactive mobile advertising platform system and method 10 has been described in detail herein, the invention is not necessarily so limited and other examples, embodiments, uses, modifications, and departures from the embodiments, examples, uses, and modifications may be made without departing from the shared interactive mobile advertising platform system and method 10 and all such embodiments are intended to be within the scope and spirit of the appended claims.

What is claimed is:

1. A method of advertising to a member of an audience, the method of advertising comprising the acts of:
providing a shared interactive mobile advertising platform for advertising to the member of the audience;
providing a shared interactive mobile advertising platform and providing the shared interactive mobile advertising platform with a messaging display;
providing an advertising campaign wherein the act of providing the advertising campaign includes creating a response code and a data collection destination for use in connection with the advertising campaign;
displaying the response code and the data collection destination on the messaging display;
providing an advertising message and displaying the advertising message on the messaging display; and,
positioning the messaging display such that the messaging display is viewable by the member of the audience.

2. The method of advertising according to claim 1 further wherein the member of the audience has a personal communication device and allowing the member of the audience the choice of opting in so as to be able to receive the advertising message by inputting the response code and a data collection destination into the personal communication device wherein the shared interactive mobile advertising platform sends a response to the member of the audience.

3. The method of advertising according to claim 1 further including the step providing an advertising user and providing the response code to be in the form of a keyword and providing the data collection destination to be in the form of a short code and wherein the advertising user generates the an advertising message, the keyword, and the short code.

4. The method of advertising according to claim 3 further including providing the advertising message to be in the form of printed indicia, words and/or graphics and wherein the advertising message pertains to at least one of the following: political advertising, sales, events, coupons, games, an alert, religion, meeting dates and public service information.

5. The method of advertising according to claim 1 further including the act of programming the shared interactive mobile advertising platform with the advertising campaign and advertising message.

6. The method of advertising according to claim 1 further including the act of providing the advertising space on the messaging display and providing an advertising user, and providing a platform owner of the shared interactive mobile advertising platform and the platform owner generates revenue by renting the advertising space to an advertising user for a fee.

7. The method of advertising according to claim 3 further including the act storing the phone numbers of the members of the audience that opted in and directly advertising to the members that opted in by using the phone numbers.

8. The method of advertising according to claim 1 further including the act of mounting the shared interactive mobile advertising platform on a vehicle and after a predetermined amount of time moving the shared interactive mobile advertising platform from one location to another location and displaying the response code and a data collection destination on the messaging display while the vehicle is in operation.

9. The method of advertising according to claim 1 further including providing the shared interactive mobile advertising platform with an interface allowing communication between the shared interactive mobile advertising platform and a member of an audience by way of the personal communication device.

10. The method of advertising according to claim 9 further including the act of providing the shared interactive mobile advertising platform with a memory for storing advertising campaign and the advertising message in the memory such that the advertising campaign and the advertising message are capable of being displayed on the messaging display.

11. A system for advertising to a member of an audience, the system comprising:
a shared interactive mobile advertising platform for advertising to the member of the audience and wherein the a shared interactive mobile advertising platform has a messaging display;
an advertising campaign having a response code and a data collection destination for display on the messaging display;
an advertising space defined on the messaging display and the advertising space is for display on the response code and the data collection destination;
an advertising message displayed in the advertising space defined on the messaging display; and,
wherein the shared interactive mobile advertising platform is capable of being moved from one location to another location.

12. The system according to claim 11 further including a vehicle and the shared interactive mobile advertising platform is mounted on the vehicle.

13. The system according to claim 12 wherein the shared interactive mobile advertising platform includes a specially programmed general purpose computer having a processor and a memory and for storing advertising message data and displaying the advertising message data on the messaging display.

14. The system according to claim 12 wherein the messaging display defines advertising space, and an advertising user rents the advertising space from a platform owner in exchange for a fee.

15. The system according to claim 11 wherein the shared interactive mobile advertising platform further includes an interface and the member of the audience has a personal communication device and wherein the member is opted into the advertising campaign by inputting the response code and the data collection destination into the personal communication device.

16. The system according to claim 15 wherein the response code is a keyword and the data collection destination is a short code and wherein the personal communication devices of the opted in members have phone numbers and the phone numbers are collected and saved by the shared interactive mobile advertising platform for advertising campaigns.

17. The system according to claim 11 wherein the advertising message is in the form of printed indicia, words and/or graphics and wherein the advertising message pertains to at least one of the following: political advertising, games, sales, events, coupons, religion, an alert, meeting dates and public service information.
